(19) United States
(12) Patent Application Publication
(10) Pub. No.: US 2017/0203691 A1
(43) Pub. Date: Jul. 20, 2017

(54) VEHICLE OF NO BLIND SPOT

(71) Applicants: Yu-Chen Chou, Pingtung City (TW); Po-Jen Tsai, Kaohsiung City (TW)

(72) Inventors: Yu-Chen Chou, Pingtung City (TW); Po-Jen Tsai, Kaohsiung City (TW)

(21) Appl. No.: 15/001,265

(22) Filed: Jan. 20, 2016

(51) Int. Cl. B60R 1/00; H04N 5/232; H04N 7/18

(52) U.S. Cl. CPC B60R 1/00; H04N 7/181; H04N 5/23293; G02B 27/01

(57) ABSTRACT

The vehicle of no blind spot contains a vehicle body, a number of monitoring devices along the vehicle body's circumference, a number of display devices inside the vehicle electrically connected to at least a corresponding monitoring device. The display device contains a flexible screen. By presenting views around the front, center, and rear pillars, the driver's blind spot problem is resolved and driving safety is enhanced.

### BACKGROUND OF THE INVENTION

(a) Technical Field of the Invention

The present invention is generally related to motor vehicles, and more particular to a motor vehicle incorporating a dashcam system so as to achieve no blind spot to the driver.

(b) Description of the Prior Art

Despite that technology advancement has provided people with even faster transportation means, automobiles are still one of the most popular motor vehicles.

However, the front, center, and rear pillars of a motor vehicle often block a driver's view and traffic accidents due to the blind spots caused by these pillars are not uncommon.

### SUMMARY OF THE INVENTION

Therefore, the present invention provides a vehicle of no blind spot that, through monitoring devices capturing images outside the vehicle and display devices presenting the captured images to a driver of the vehicle, so as to prevent blind spots and traffic accident.

The vehicle of no blind spot contains a vehicle body, at least a monitoring device configured along the vehicle body's circumference, and at least a display device configured inside the vehicle body and electrically connected to at least a corresponding monitoring device.

The monitoring device is configured on an outer side of a front pillar, a center pillar, or a rear pillar of the vehicle body

The display device is configured on an inner side of a front pillar, a center pillar, or a rear pillar of the vehicle body.

Alternatively, the display device is integrated with a rear-view mirror or a head-up display of the vehicle body.

Preferably, the display device contains a flexible screen.

Preferably, the display device contains one of a liquid crystal display (LCD) screen, a light emitting diode (LED) LCD screen, a capacitance screen, and a micro-projector screen.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top-view diagram showing a vehicle of no blind spot according to an embodiment of the present invention.

FIG. 2 is a side-view diagram showing the vehicle of FIG. 1.

FIG. 3 is a perspective diagram showing the inside of the vehicle of FIG. 1 when the vehicle is operated.

FIG. 4 is another perspective diagram showing the inside of the vehicle of FIG. 1 when the vehicle is backed up.

FIG. 5 is another perspective diagram showing the inside of the vehicle of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

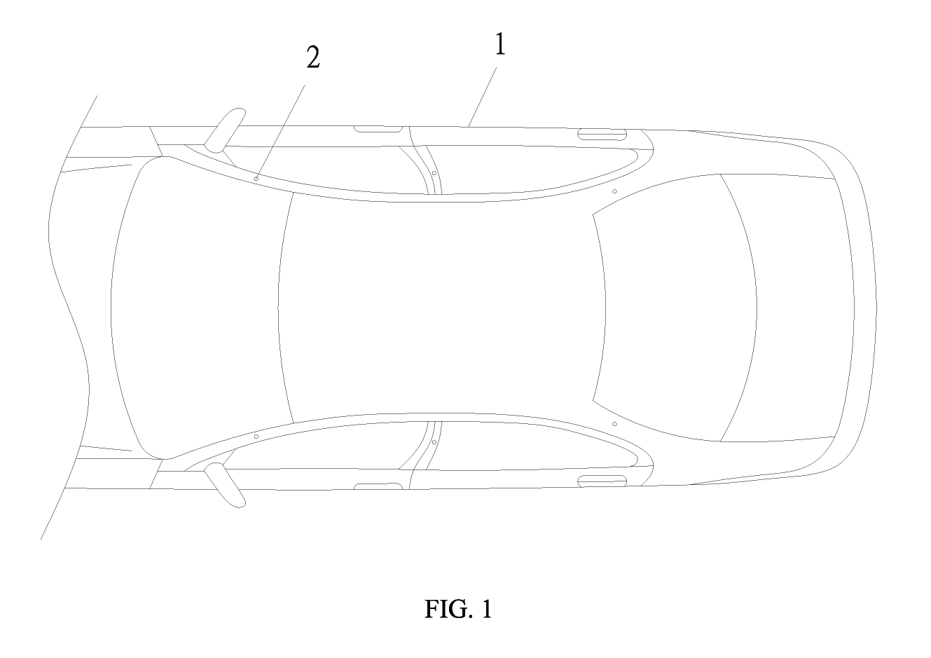

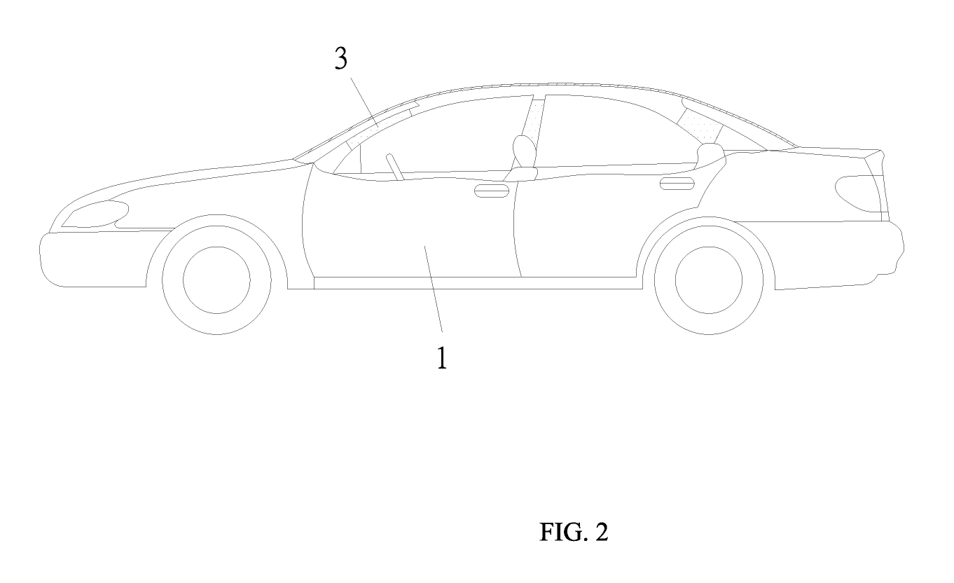

As shown in FIGS. 1 and 2, a vehicle of no blind spot according to an embodiment of the present invention contains a vehicle body 1, a number of monitoring devices 2 configured along the vehicle body 1's circumference, and a number of display devices 3 configured inside the vehicle body 1. The monitoring devices 2 are electrically connected to the display devices 3, respectively.

The monitoring devices 2 are configured on an outer side of at least a front pillar, at least a center pillar, at least a rear pillar, and tail of the vehicle body 1.

The display devices 3 are configured on an inner side of at least a front pillar, at least a center pillar, and at least a rear pillar of the vehicle body 1.

Each display device 3 contains a liquid crystal display (LCD) screen, a light emitting diode (LED) LCD screen, a capacitance screen, a micro-projector screen, or a flexible screen.

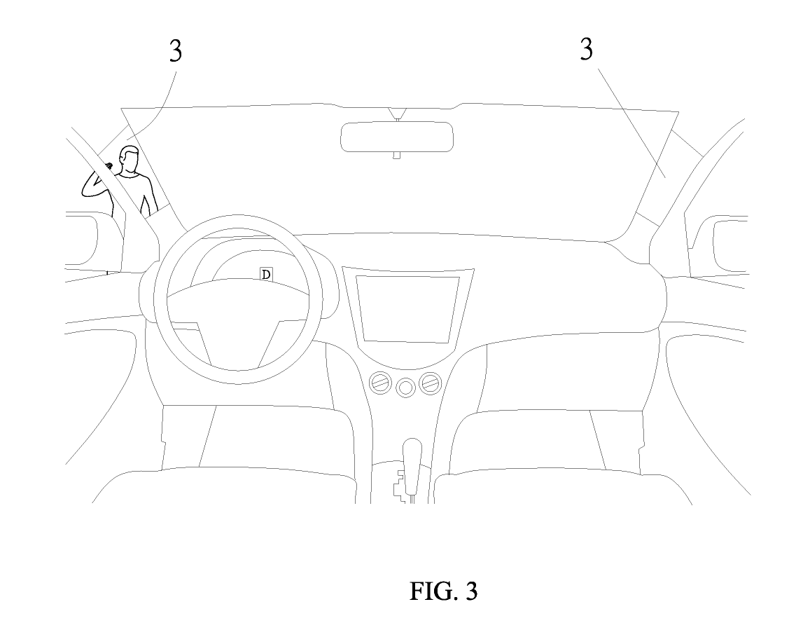

As shown in FIG. 3, when the vehicle is ignited, the monitoring and display devices 2 and 2 is started automatically. Each of the monitoring devices 2 captures outside images around the front pillar, the center pillar, the rear pillar, or the tail of the vehicle body 1 where the monitoring device 2 is installed. The captured images are then presented on a display device 3 electrically connected to the monitoring device 2. As such, the view originally blocked by the front, center, or rear pillar can now be perceived by the driver.

The vehicle can further contain a control device (not shown) configured inside the vehicle body 1 electrically connected to the display devices 3 and the monitoring devices 2 so that the monitoring devices 2 and the display devices 3 configured on the front, center, and rear pillars can be individually turned on and off. The control device can also function as an event data recorder to store the images captures by the monitoring devices 2.

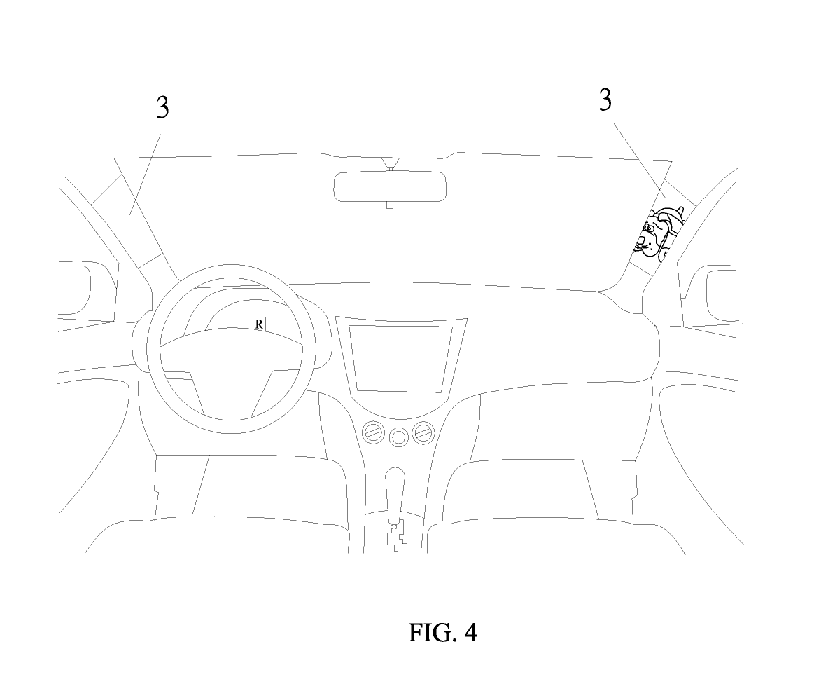

As shown in FIG. 4, when the vehicle is put into reverse gear and is backed up, the images captured by the monitoring device 2 at the vehicle body 1's tail provide a view behind the vehicle body 1, so as to enhance the safety when backing up the vehicle. The captured images can be selectively delivered to and displayed on one of the display devices 3. In other words, when the vehicle is driven forward, the display devices 3 provide views outside and around the front, center, and rear pillars whereas, when the vehicle is driven backward, a display device 3 is automatically or manually switched to present the view around the rear end of the vehicle.

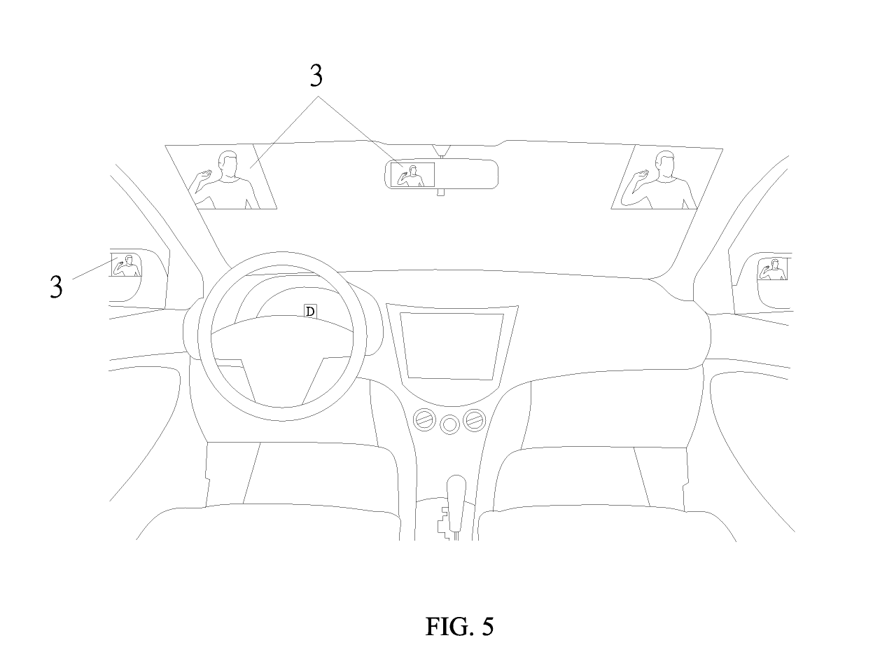

As shown in FIG. 5, a display device 3 can be integrated with a rear-view mirror, or integrated with a head-up display, thereby achieving even more convenient viewing.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A vehicle of no blind spot comprising
a vehicle body;
at least a monitoring device configured along the vehicle body's circumference; and
at least a display device configured inside the vehicle body and electrically connected to at least a corresponding monitoring device.

2. The vehicle of no blind spot according to claim 1, wherein the monitoring device is configured on an outer side of a front pillar, a center pillar, or a rear pillar of the vehicle body.

3. The vehicle of no blind spot according to claim 1, wherein the display device is configured on an inner side of a front pillar, a center pillar, or a rear pillar of the vehicle body.

4. The vehicle of no blind spot according to claim 3, wherein the display device is integrated with a rear-view minor or a head-up display of the vehicle body.

5. The vehicle of no blind spot according to claim 4, wherein the display device comprises a flexible screen.

6. The vehicle of no blind spot according to claim 4, wherein the display device comprises one of a liquid crystal display (LCD) screen, a light emitting diode (LED) LCD screen, a capacitance screen, and a micro-projector screen.
